(19) United States
(12) Patent Application Publication
(10) Pub. No.: US 2012/0078439 A1
(43) Pub. Date: Mar. 29, 2012

(54) VEHICLE INFORMATION STORING APPARATUS

(75) Inventors: Daisuke Tokumochi, Anjo-city (JP); Shouichirou Hanai, Anjo-city (JP)

(73) Assignee: DENSO CORPORATION, Kariya-city (JP)

(21) Appl. No.: 13/232,420

(22) Filed: Sep. 14, 2011

(30) Foreign Application Priority Data
Sep. 27, 2010 (JP) 2010-215234
Oct. 25, 2010 (JP) 2010-238504

(51) Int. Cl. G06F 7/00; G01C 21/00

(52) U.S. Cl. 701/1

(57) ABSTRACT

A vehicle information storing apparatus stores a camera image, acceleration or the like, which a user selected from vehicle information stored in a RAM, and an intersection, a curve or the like of navigation information into a flash memory under a predetermined condition. The predetermined condition may include that a user performed a vehicle information selection operation for selecting the camera image or acceleration, the user performed a specific item selection operation for setting the intersection or curve, a vehicle enters within a predetermined distance range from a set location and navigation information received from a navigation device satisfies a predetermined condition.

### CROSS REFERENCE TO RELATED APPLICATION

This application is based on and incorporates herein by reference Japanese patent applications No. 2010-215234 filed on Sep. 27, 2010 and No. 2010-238504 filed on Oct. 25, 2010.

### FIELD OF THE INVENTION

The present invention relates to a vehicle information storing apparatus, which includes a volatile memory for sequentially storing vehicle information during vehicle traveling and a non-volatile memory capable of storing the vehicle information stored in the volatile memory.

### BACKGROUND OF THE INVENTION

Recently, a vehicle information storing apparatus sequentially stores vehicle information (for example, camera image and acceleration information) during vehicle traveling so that the vehicle information stored before and after occurrence of a vehicle accident may be referred to as evidentiary information in analyzing the vehicle accident or the like (for example, patent documents 1 and 2).
Patent document 1: JP 2004-62689A (US 2005/0246079 A1)
Patent document 2: JP 2008-165433A

The conventional vehicle information storing apparatus disclosed in the patent documents 1 and 2 has a RAM (volatile memory), the storage content of which is erased when power supply is shut off, and a flash memory (non-volatile memory), the storage content of which is not erased even when the power supply is shut off. Vehicle information is sequentially stored in the RAM during vehicle travel. When a predetermined condition (for example, acceleration becomes greater than a threshold value) is satisfied, a part of vehicle information (for example, vehicle information useful for vehicle accident analysis) of the vehicle information stored in the RAM is stored in the flash memory. The vehicle information stored in the flash memory as indicating vehicle information before and after vehicle accident is retrieved to analyze the vehicle accident.

The conventional vehicle information storing apparatus stores the predetermined vehicle information when the predetermined condition is satisfied. However it does not store other arbitrary vehicle information. In view of wide use of a navigation device, a user wants to store vehicle information and navigation information in a correlated or associated manner for analyzing his or her own habit of driving. The conventional vehicle information storing apparatus is not capable of meeting such a user's desire.

### SUMMARY OF THE INVENTION

It is therefore one object of the present invention to provide a vehicle information storing apparatus, which stores other vehicle information, which a user wants, and navigation information in a correlated manner for higher added value.

It is another object of the present invention to provide a vehicle information storing apparatus, which stores both predetermined vehicle information and user-designated vehicle information.

According to one aspect of the present invention, a vehicle information storing apparatus for a vehicle is connected to a navigation device. The vehicle information storing apparatus comprises a vehicle information input section, a volatile storage section, a non-volatile storage section, a vehicle information selection operation receiving section, a navigation information inputting section and a control section.

The vehicle information input section receives vehicle information during travel of a vehicle. The volatile storage section stores sequentially the vehicle information received by the vehicle information input section. The non-volatile storage section stores the vehicle information stored in the volatile storage section. The vehicle information selection operation receiving section receives a vehicle information selection operation performed by a user to select the vehicle information. The navigation information inputting section receives navigation information from the navigation device. The control section checks whether the navigation information received by the navigation information input section satisfies a predetermined condition. The control section correlates and stores in the non-volatile storage section the vehicle information and the navigation information, when the navigation information is determined to satisfy the predetermined condition. The vehicle information is selected by the vehicle information selection operation of the user from the vehicle information stored in the volatile storage section.

According to another aspect of the present invention, a vehicle information control apparatus comprises a vehicle information input section, a volatile storage section, a first non-volatile storage section, a predetermined condition check section, a first storing operation control section, a vehicle information designation operation receiving section, a storing time designation operation receiving section, storing time designation operation receiving section, a storing time check section, a second non-volatile storage section and a second storing operation control section.

The vehicle information input section receives vehicle information during travel of a vehicle. The volatile storage section stores sequentially the vehicle information received by the vehicle information input means. The first non-volatile storage section is provided to store predetermined vehicle information among the vehicle information stored in the volatile storage section. The predetermined condition check section checks whether a predetermined condition, in which the predetermined vehicle information is to be stored in the first non-volatile storage section, is satisfied. The first storing operation control section performs a first storing operation to store the predetermined vehicle information in the first non-volatile storage section when the predetermined condition check section determines that the predetermined condition is satisfied. The vehicle information designation operation receiving section receives a vehicle information designation operation performed by a user to designate user-designated vehicle information among the vehicle information stored in the volatile storage section. The storing time designation operation receiving section receives a storing time designation operation performed by the user to designate a storing time. The storing time check section checks whether the storing time is designated as a user-designated storing time by the storing time designation operation receiving section. The second non-volatile storage section is provided separately from the first non-volatile storage section to store the user-designated vehicle information. The second storing operation control section stores the user-designated vehicle information in the second non-volatile storage section at the user-designated storing time.

### BRIEF DESCRIPTION OF THE DRAWINGS

The above and other objects features and advantages of the present invention will become more apparent from the following detailed description made with reference to the accompanying drawings. In the drawings:

FIG. 1 is a functional block diagram of a vehicle electronic control system including a vehicle information storing apparatus according to a first embodiment of the present invention;

FIGS. 2A and 2B are illustrations of an object selection screen and a camera selection screen in the first embodiment, respectively;

FIGS. 3A and 3B are illustrations of an acceleration selection screen and a specific item selection screen in the first embodiment, respectively;

FIG. 4 is an illustration of a location selection screen in the first embodiment;

FIGS. 5A and 5B are illustrations of a navigation function selection screen and a fuel consumption selection screen in the first embodiment,

respectively;

FIGS. 6A and 6B are illustrations of a safety drive selection screen and a travel record selection screen in the first embodiment, respectively;

FIG. 7 is a diagram of transition of display screens in the first embodiment;

FIG. 8 is a flowchart of a main routine performed in the first embodiment;

FIG. 9 is a flowchart of a selection operation receiving processing in the first embodiment;

FIG. 10 is a flowchart of vehicle information storing processing in the first embodiment;

FIG. 11 is a flowchart of vehicle information outputting processing in the first embodiment;

FIG. 12 is a flowchart of mandatory storing operation receiving processing in the first embodiment;

FIGS. 13A and 13B are time charts of storing vehicle information in a flash memory in the first embodiment;

FIG. 14 is a functional block diagram of a vehicle electronic control system including a vehicle information storing apparatus according to a second embodiment of the present invention;

FIG. 15 is a table showing a relation among vehicle information, a vehicle information designation operation and a storing time designation operation (interval) in the second embodiment;

FIG. 16 is a table showing a relation among vehicle information, a vehicle information designation operation and a storing time designation operation (condition) in the second embodiment;

FIG. 17 is a flowchart of a main routine performed in the second embodiment;

FIG. 18 is a flowchart of vehicle information storing processing in the second embodiment;

FIG. 19 is a flowchart of vehicle information outputting processing in the second embodiment; and

FIG. 20 is a flowchart of storage condition acquisition processing in the first embodiment.

### DETAILED DESCRIPTION OF THE PREFERRED EMBODIMENT

The present invention will be described with reference to embodiments shown in the drawings.

### First Embodiment

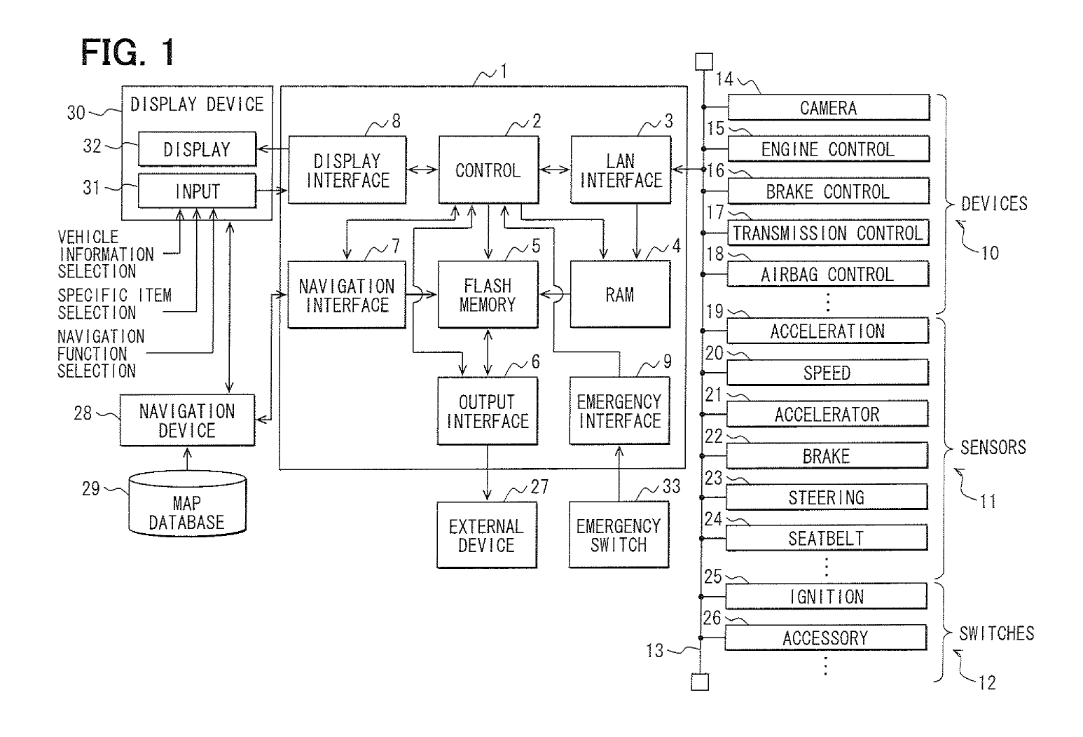

Referring to FIG. 1, a vehicle information storing apparatus 1 is mounted in a vehicle as a part of a vehicle electronic control system. Specifically the vehicle information storing apparatus 1 is, for example, fixedly located beneath a rear seat in a passenger compartment and protected by a rigid casing from being damaged even when an impact force is applied at the time of vehicle accident.

The vehicle information storing apparatus 1 is configured with a control circuit 2 (control section and drive source stop check section), a vehicle LAN interface (I/F) circuit 3 (vehicle information input section), a RAM (volatile storage section) 4, a flash memory (non-volatile storage section) 5, an output interface circuit (external output section) 6, a navigation device interface circuit (navigation information input section) 7, a display device interface circuit (vehicle information selection operation receiving section and a navigation function selection receiving section) 8, and an emergency switch interface circuit (mandatory storing operation receiving section) 9.

The control circuit 2 includes a CPU, which is a microcomputer, a RAM, a ROM, an input/output (I/O) bus and the like, and executes control programs thereby to control operations of the vehicle LAN interface circuit 3, the RAM 4, the flash memory 5, the output interface circuit 6, the navigation device interface circuit 7 and the display device interface circuit 8.

The vehicle LAN interface circuit 3 is connected via vehicle LAN 13 to various devices (vehicle information output section) 10 mounted in the vehicle, various sensors (vehicle information output section) 11 and various switches (vehicle information output section) 12. The various devices 10 include a camera (imaging section) 14, an engine control device 15, a brake control device 16, a transmission control device 17 and an airbag control device 18. The camera device 14 outputs a signal, by which a camera image can be specified. The engine control device 15 outputs a signal, by which a rotation speed of an engine can be specified. The brake control device 16 outputs a signal, by which a brake fluid pressure can be specified. The transmission control device 17 outputs a signal, by which a shift position can be specified. The airbag control device 18 outputs a signal, by which an airbag on/off condition can be specified.

The various sensors 11 include an acceleration sensor (acceleration detection section) 19, a vehicle travel speed sensor 20, a brake sensor 22, a steering sensor 23, a seatbelt sensor 24 and the like. The acceleration sensor 19 outputs a signal, by which an acceleration (accelerated velocity) can be specified. The speed sensor 20 outputs a signal, by which a travel speed (vehicle speed) can be specified. The brake sensor 22 outputs a signal, by which a brake operation amount can be specified. The steering sensor 23 outputs a signal, by which a steering angle of a steering wheel can be specified. The seatbelt sensor 24 outputs a signal, by which a seatbelt on/off condition can be specified.

The various switches 12 include an ignition switch 25, an accessory switch 26 and the like. The ignition switch 25 outputs a signal, by which an on/off condition of the power supply by the ignition switch 25 can be specified. The accessory switch 26 outputs a signal, by which an on/off condition of the power supply by the accessory switch 26 can be specified.

The information specified by the signals outputted from the devices 10, the sensors 11 and the switches 12 are referred to vehicle information generally. The devices 10, sensors 11 and the switches 12 may include other devices, sensors and switches.

The vehicle LAN interface circuit 3 receives the signals outputted from the devices 10, the sensors 11 and the switches 12 through the LAN 13 and outputs the inputted signals to the control circuit 2 and the RAM 4. The control circuit 2 receives the signals outputted from the vehicle LAN interface circuit 3 and analyzes the vehicle information specified by the received signals.

The RAM 4 receives the signals outputted from the vehicle LAN interface circuit 3 and sequentially stores the vehicle information specified by the received signals. That is, when the RAM 4 receives the signals from the vehicle LAN interface circuit 3 in an amount, which exceeds its storage capacity, the RAM 4 stores (overwrites) the vehicle information specified by the latest signal while erasing the oldest vehicle information, which is in the RAM 4 at that moment. Thus, the vehicle information, which is specified by the signal received from the vehicle LAN interface circuit 3, is sequentially stored in the RAM 4. When the power supply for the vehicle information storing apparatus 1 is shut off, the memory content (vehicle information) stored in the RAM 4 is erased.

The flash memory 5 is configured to be capable of storing a part of the vehicle information stored in the RAM 4. The control circuit 2 outputs a transfer command to the RAM 4 and a write command to the flash memory 5 so that the part of vehicle information stored in the RAM 4 may be stored (copied) into the flash memory 5. The storage content in the flash memory 5 is maintained without being erased, even when the power supply for the vehicle information storing apparatus 1 is shut off.

The output interface circuit 6 has a communication function for communicating with an external device 27, which is carried by a user for example. When the output interface circuit 6 receives a retrieval command from the control circuit 2 under the condition that it is capable of communication with the external device 27, it retrieves information (vehicle information and navigation information described below) stored in the flash memory 5 and transmits the retrieved information to the external device 27. The external device 27 has a display function. When the external device 27 receives the vehicle information sent form the output interface circuit 6, it displays the received information thereby to provide the user with the information stored in the flash memory 5. The communication performed between the output interface circuit 6 and the external device 27 may be a wired communication or a short-distance wireless communication. For example, the wired communication may be USB communication and the short-distance wireless communication may be Bluetooth (trademark) communication.

The navigation device interface circuit 7 has a function of receiving navigation information transmitted from a navigation device 28. When the navigation device interface circuit 7 receives the navigation information transmitted from the navigation device 28, it outputs the received navigation information to the control circuit 2. The navigation information transmitted from the navigation device 28 includes a vehicle location (present position of the vehicle), a vehicle travel route and present time. The navigation device 28 has a function of specifying a vehicle location, a function of setting a destination, a function of searching for a route from the vehicle location to the destination, a function of drawing a map retrieved from a map database 20 stored in a record medium, a function of displaying the vehicle location and the travel guide route by superimposition, a function of guiding the travel guide route. The vehicle information storing apparatus 1 and the navigation device 28 are wire-connected, for example.

A display device 30 is provided with an operation input circuit 31, which functions as an operation input device for the navigation device 28, and a display circuit 32, which functions as a display screen of the navigation device 28. The display device 30 has a function of receiving various input operations of a user by the operation input circuit 31. The various input operations include a destination setting operation of a user for setting a destination and a reduction scale changing operation for changing the reduction scale of a map. The display device 30 also has a function of displaying various screens on the display circuit 32. The various screens include a menu screen, a destination setting screen, a travel guide route screen and the like.

When the display device 30 receives a vehicle information selection operation for selecting vehicle information, which the user requests, at the operation input circuit 31, it transmits a vehicle information selection signal to the display device interface circuit 8. The vehicle information, which the user selected, can be specified by the vehicle information selection signal. When the device 8 receives the vehicle information selection signal transmitted from the display device 30, it outputs the received vehicle information selection signal to the control circuit 2. When the control circuit 2 receives the vehicle information selection signal outputted from the display device interface circuit 8, it sets (stores) the vehicle information, which is specified by the inputted vehicle information selection signal, that is, which is selected by the user by the vehicle LAN interface circuit 31.

When the display device 30 receives a specific item selection operation for selection of specific items (map, guide route, time described below), which the user wants, at the vehicle LAN interface circuit 31, it transmits a specific item selection signal, by which the specific item selected by the user can be specified, to the display device interface circuit 8. When the display device interface circuit 8 receives the specific item selection signal transmitted from the display device 30, it outputs the received specific item selection signal to the control circuit 2. When the control circuit 2 receives the specific item selection signal outputted from the display device interface circuit 8, it sets the specific item specified by the received specific item selection signal, that is, the specific item, which the user selected by the vehicle LAN interface circuit 31.

When the display device 30 receives at the vehicle LAN interface circuit 31a navigation function selection operation for selection of the navigation function (fuel consumption, safety drive and travel record described below), which the user requests, it transmits a navigation function selection signal, by which the navigation function selected by the user can be specified, is transmitted to the display device interface circuit 8. When the display device interface circuit 8 receives the navigation function selection signal transmitted from the display device 30, it outputs the received navigation function selection signal to the control circuit 2. When the control circuit 2 receives the navigation function selection signal outputted from the display device interface circuit 8, it sets the navigation function specified by the received navigation function selection signal, that is, the navigation function, which the user selected by the vehicle LAN interface circuit 31. The vehicle information storing apparatus 1 and the display device 30 are wire-connected for example.

When the emergency switch interface circuit 9 receives an emergency signal transmitted from the emergency switch 33 operated by the user, it outputs the received emergency signal to the control circuit 2. The emergency switch 33 is located at a position, at which the user can quickly operate immediately after recognizing occurrence of emergency, and may be a switch, which the user may easily operate even in driving a vehicle. The vehicle information storing apparatus 1 and the emergency switch 33 are wire-connected for example.

The vehicle information storing apparatus 1 configured as described above and mounted in the vehicle is connected to respond to the on/off of the accessory switch 26 by receiving an accessory signal from the accessory switch 26. When the accessory switch 26 is in the on-state, the power supply for the vehicle information storing apparatus 1 is in the turned-on (activated state). When the accessory switch 26 is in the off-state, the power supply for the vehicle information storing apparatus 1 is in the turned-off state (shutoff-state). When the power supply for the vehicle information storing apparatus 1 is in the turned-on state (activated-state), the vehicle information storing apparatus 1 continues to perform normal operation without limiting its functions. When the power supply for the apparatus 1 is in the turned-off state (shutoff-state), the vehicle information storing apparatus 1 performs low power operation by limiting its function. The low power operation consumes less power than the normal operation.

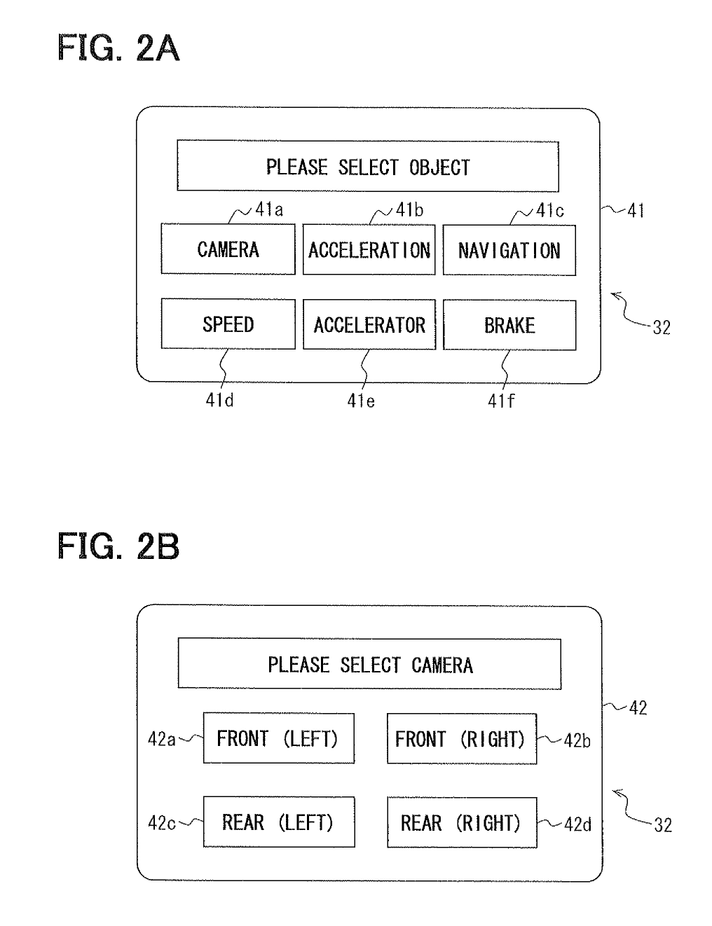

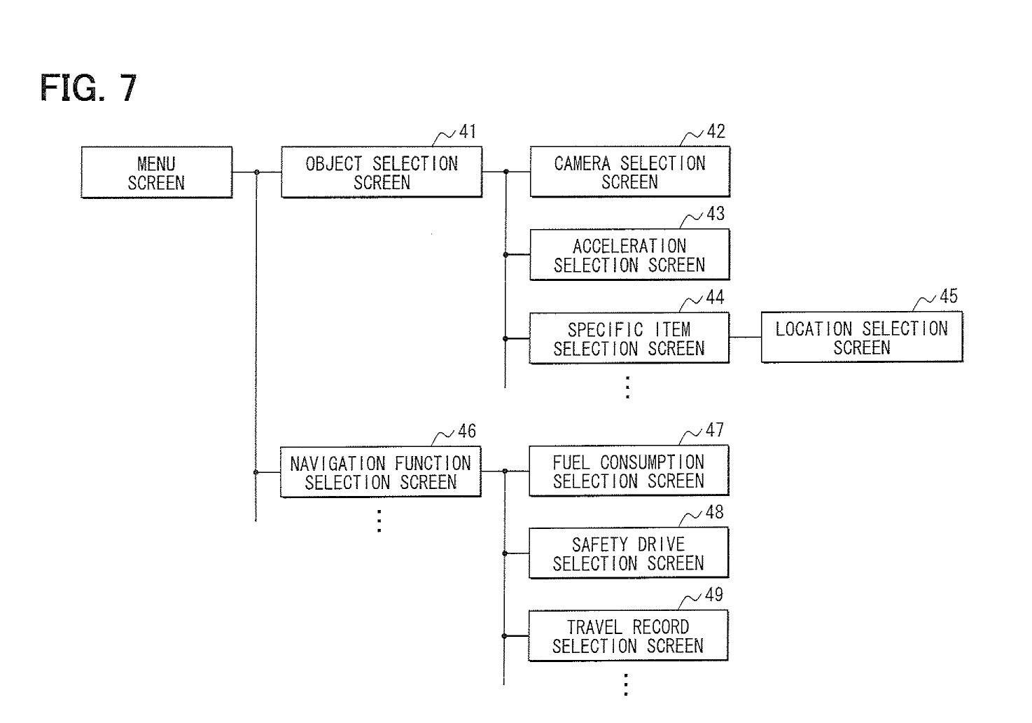

According to the foregoing configuration, the user can set the vehicle information, the specific information and the navigation function, which the user selects, in the control circuit 2, by performing the vehicle information selection operation, the specific item selection operation (selection of map, guide route and time) and the navigation function selection function (selection of fuel consumption, safety drive and travel record) by operating the vehicle LAN interface circuit 31 of the display device 30. The vehicle information selection operation, the specific item selection operation and the navigation function selection operation, which the user performs, will be described with reference to FIGS. 2A to 7. FIGS. 2A to 6B show examples of display screens displayed on a display panel of the display circuit 32 when the user performs the vehicle information selection operation, the specific item selection operation and the navigation function selection operation. FIG. 7 shows one example of transition of the display screens.

While the control circuit 2 causes the display device 30 (display circuit 32) to display a menu screen (not shown), an “object selection screen” key, a “navigation function selection screen” key are displayed so that the user is allowed to operate the “object selection screen” key and the “navigation function selection screen” key on the menu screen. When the control circuit 2 determines that the user operated the “object selection screen” key on the menu screen, it causes the display device 30 to display an object selection screen 41 as shown in FIG. 2A. The user is allowed to operate a “camera” key 41a, an “acceleration” key 41b, a “navigation” key 41c, a “speed” key 41d, an “accelerator” key 41e and a “brake” key 41f.

When the control circuit 2 determines that the user operated the “camera” key 41a on the object selection screen 4, it causes the display device 30 to display a camera selection screen 42 as shown in FIG. 2B. The user is allowed to operate a “front (left)” key 42a, a “front (right)” key 42b, a “rear (left)” key 42c and a “rear (right)” key 42d. In this case, the user is allowed to select at least one of four cameras, which image a front left scenery, a front right scenery, a rear left scenery and a rear right scenery of the vehicle, respectively. The number of camera devices are not limited to four. It is also possible that cameras, which images a front scenery, a rear scenery, a left scenery and a right scenery may be provided selectively. If the camera device is capable of changing its imaging angle, the imaging angle may be selectable.

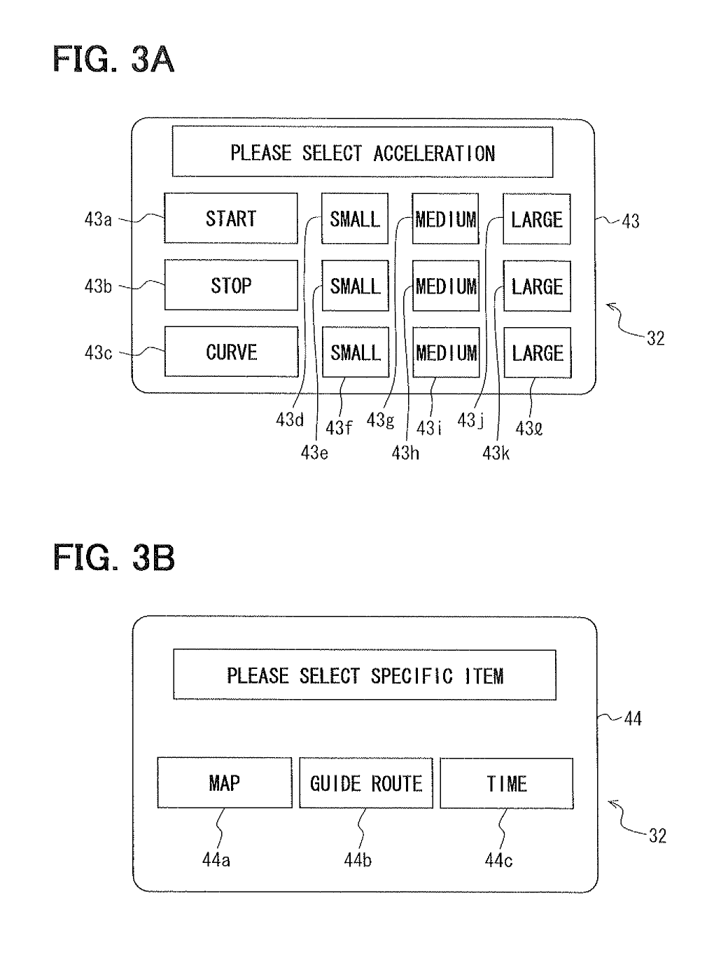

When the control circuit 2 determines that the user operated the “acceleration” key 41b on the object selection screen 41, it causes the display device 30 to display the acceleration selection screen 43 as shown in FIG. 3A. The user is allowed to operate a “start” key 43a, a “stop” key 43b, a “curve” key 43c, “small” keys 43d to 43f, “medium” keys 43g to 43i and “large” keys 43j to 43li. In this case, the user is allowed to select driving operations such as start, stop and curve, which is desired to be stored, and a road shape. Further, the user is allowed to select one of degrees of acceleration (small, medium and large) for each. When the user selects “start” or “stop,” an output value of the acceleration sensor, which detects acceleration in a forward-rearward direction of the vehicle, is used. When “small” is subsequently selected, the output value indicating a small magnitude of the acceleration sensor, which detects acceleration in the forward-rearward direction, is stored. When “small” and “medium” are selected, output values of the acceleration sensor indicating both small and medium magnitudes are stored. When the user selects “curve,” an output value of the acceleration sensor, which detects acceleration in a right-left direction of the vehicle, is used. It is also possible to input actual acceleration values in place of “small,” “medium,” and “large.”

When the control circuit 2 determines that the user operated the “navigation” key 41c on the object selection screen 41, it causes the display device 30 to display the specific item selection screen 44 as shown in FIG. 3B. The user is allowed to operate a “map” key 44a, a “guide route” key 44b, and a “time” key 44c. The user is allowed to select specific items by operating the “map” key 44a, the “guide route” key 44b and the “time” key 44c on the specific item selection screen 44.

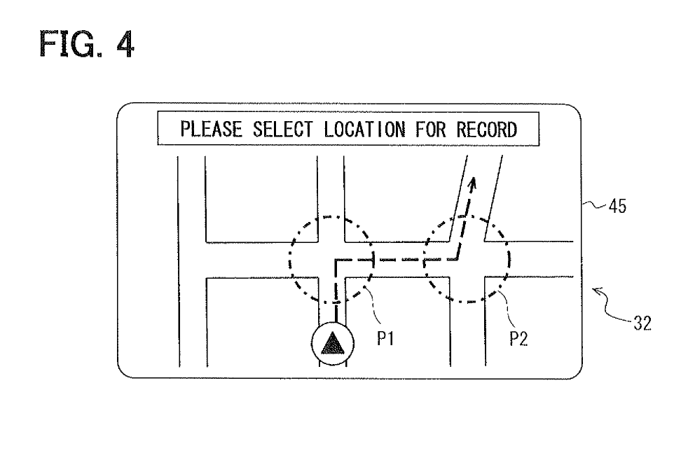

When the control circuit 2 determines that the user operated the “map” key 44a on the object selection screen 41, it causes the display device 30 to display a location selection screen 45 as shown in FIG. 4. The user is allowed to select a location (Set location). The user is thus allowed to select the location, at which the vehicle information selected is to be stored, on the selection screen 45. Specifically, by designating a desired position (P1 and P2 in FIG. 4) on the displayed map, the user is allowed to select the designated location as a position for storing the selected vehicle information. Similarly, by operating the “guide route” key 44b on the specific item selection screen 44 and designating a desired guide route, the user is allowed to select the designated guide route as a guide route for storing the selected vehicle information. Further, by operating the “time” key 44c on the specific item selection screen 44 and designating the desired time, the user is allowed to select the designated time as time for storing the selected vehicle information.

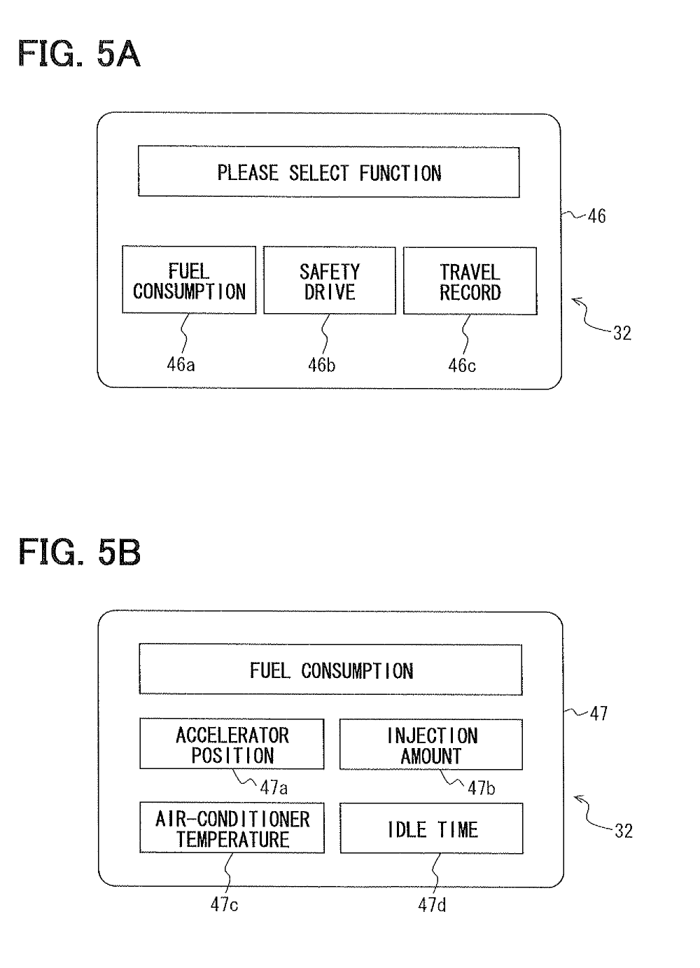

When the control circuit 2 determines that the user operated the “navigation function selection screen” key on the menu screen, it causes the display device 30 to display a navigation function selection screen 46 as shown in FIG. 5A. The user is allowed to select a “fuel consumption” key 46a, a “safety drive” key 46b and a “travel record” key 46c. The user is thus allowed to select the navigation function by operating the “fuel consumption” key 46a, the “safety drive” key 46b and the “travel record” key 46c on the navigation function selection screen 46.

When the control circuit 2 determines that the user operated the “fuel consumption” key 46a on the navigation function selection screen 46, it automatically selects vehicle information related to fuel consumption among vehicle information specified by the signals of the devices 10, the sensors 11 and the switches 12, and causes the display device 30 to display a fuel consumption selection screen 47 indicating the selected vehicle information as shown in FIG. 5B. The user is thus allowed to operate an “accelerator position” key 47a, a “fuel injection amount” key 47b, an “air-conditioner temperature” key 47c and an “idle time” key 47d. In this case, when the user operates the “accelerator position” key 47a, for example, on the fuel consumption selection screen 47, the accelerator position is selected to be an object for storing as the vehicle information related to the fuel consumption.

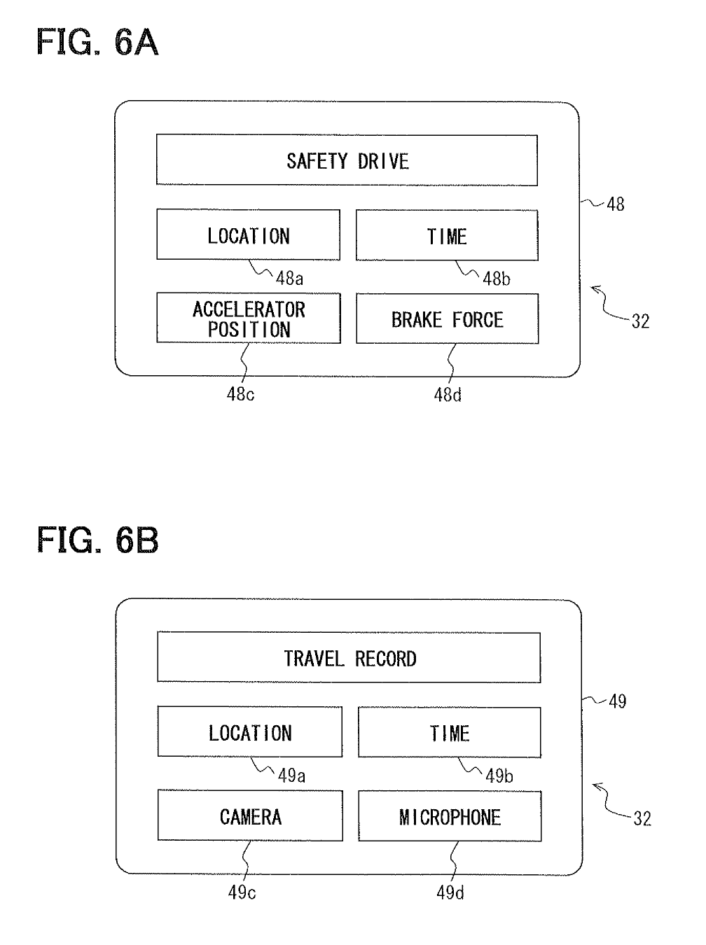

When the control circuit 2 determines that the user operated the “safety drive” key 46b on the navigation function selection screen 46, it automatically selects vehicle information related to safety drive among vehicle information specified by the signals of the devices 10, the sensors 11 and the switches 12, and causes the display device 30 to display a safety drive screen 48 indicating the selected vehicle information as shown in FIG. 6A. The user is thus allowed to operate a “location” key 48a, a “time” key 48b, an “accelerator position” key 48c and a “brake force” key 48d. In this case, when the user operates the “location” key 48a, for example, on the safety drive selection screen 48, the location is selected to be an object for storing the vehicle information related to the safety drive.

When the control circuit 2 determines that the user operated the “travel record” key 46c on the navigation function selection screen 46, it automatically selects vehicle information related to travel record among vehicle information specified by the signals of the devices 10, the sensors 11 and the switches 12, and causes the display device 30 to display a travel record selection screen 49 indicating the selected vehicle information as shown in FIG. 6B. The user is thus allowed to operate a “location” key 49a, a “time” key 49b, a “camera” key 49c and a “microphone” key 49d. In this case, when the user operates the “location” key 49a, for example, on the travel record selection screen 49, the location is selected to be an object for storing the vehicle information related to the travel record.

As described above, when the user selects any one of the fuel consumption, the safety drive and the travel record as the navigation function, the control circuit 2 automatically selects the vehicle information required for the navigation function. As a result, the user is released from selecting vehicle information.

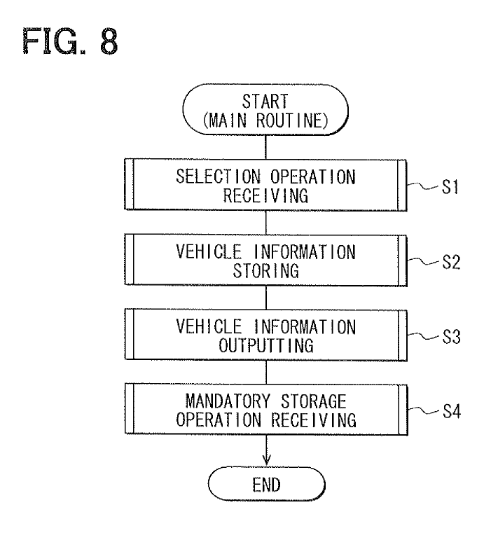

The operation of the first embodiment will be described next with reference to FIG. 8 to FIGS. 13A and 13B.

In the vehicle information storing apparatus 1, the control circuit 2 is configured or programmed to perform a main routine (processing) including sub-routines (sub-processing) shown in FIG. 8, when the power supply to the vehicle information storing apparatus 1 is in the turned-on state (accessory switch 26 is maintained in the on-state). The sub-routines are selection operation receiving processing (step S1), vehicle information storing processing (step S2), vehicle information outputting processing (step S3) and mandatory storing operation receiving processing (step S4). The control circuit 2 repeats a series of the selection operation receiving processing (step S1), the vehicle information storing processing (step S2), the vehicle information outputting processing (step S3) and the mandatory storing operation receiving processing (step S4) at a predetermined interval as described below.

### (1) Selection Operation Receiving Processing

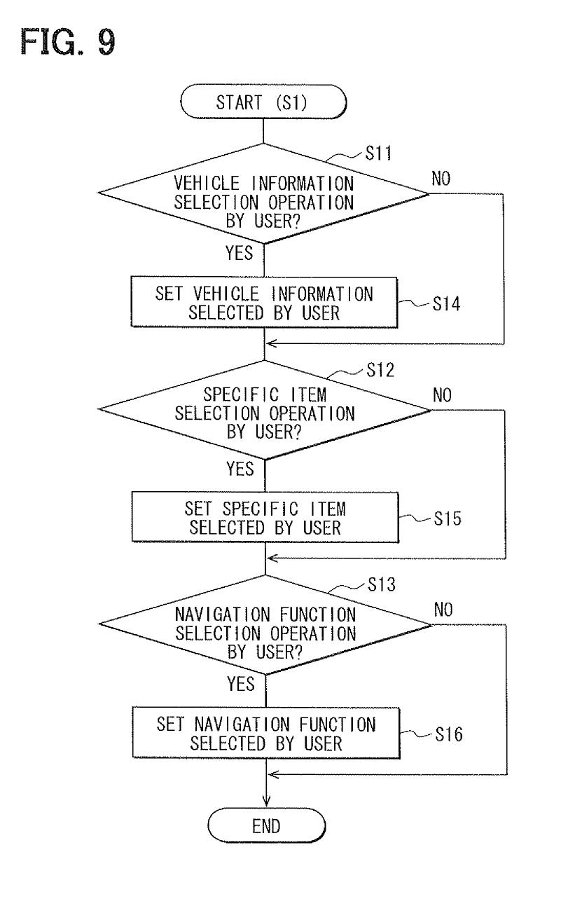

The control circuit 2 starts the selection operation receiving processing (step S1) first at a time of transition to the selection operation receiving processing. In the selection operation receiving processing, as shown in FIG. 9, the control circuit 2 checks whether the user performed the vehicle information selection operation (step S11), whether the user performed the specific item selection operation (step S12) and whether the user performed the navigation function selection operation (step S13).

When the control circuit 2 receives the vehicle information selection signal, which is generated by the user operation of the vehicle information selection on the operation input circuit 31 and transmitted from the display device 30 through the display device interface circuit 8, it determines that the user performed the vehicle information selection operation (step S11: YES) and sets the selected vehicle information based on the received vehicle information selection signal (step S14).

When the control circuit 2 receives the specific item selection signal, which is generated by the user operation of the specific item selection on the operation input circuit 31 and transmitted from the display device 30 through the display device interface circuit 8, it determines that the user performed the specific item selection operation (step S12: YES) and sets the selected specific item based on the received specific item selection signal (step S15).

When the control circuit 2 receives the navigation function selection signal, which is generated by the user operation of the navigation function selection on the operation input circuit 31 and transmitted from the display device 30 through the display device interface circuit 8, it determines that the user performed the navigation function selection operation (step S13: YES) and sets the selected navigation function based on the received navigation function selection signal (step S16).

When the control circuit 2 determines that the user did not perform any one of the vehicle information selection operation, the specific item selection operation and the navigation function selection operation, it ends the selection operation receiving processing. When the control circuit 2 determines that the user performed either one of the vehicle information selection operation, the specific item selection operation and the navigation function selection operation, it sets the selected one of the vehicle information, the specific item and the navigation function thus ending the selection operation receiving processing.

### (2) Vehicle Information Storing Processing

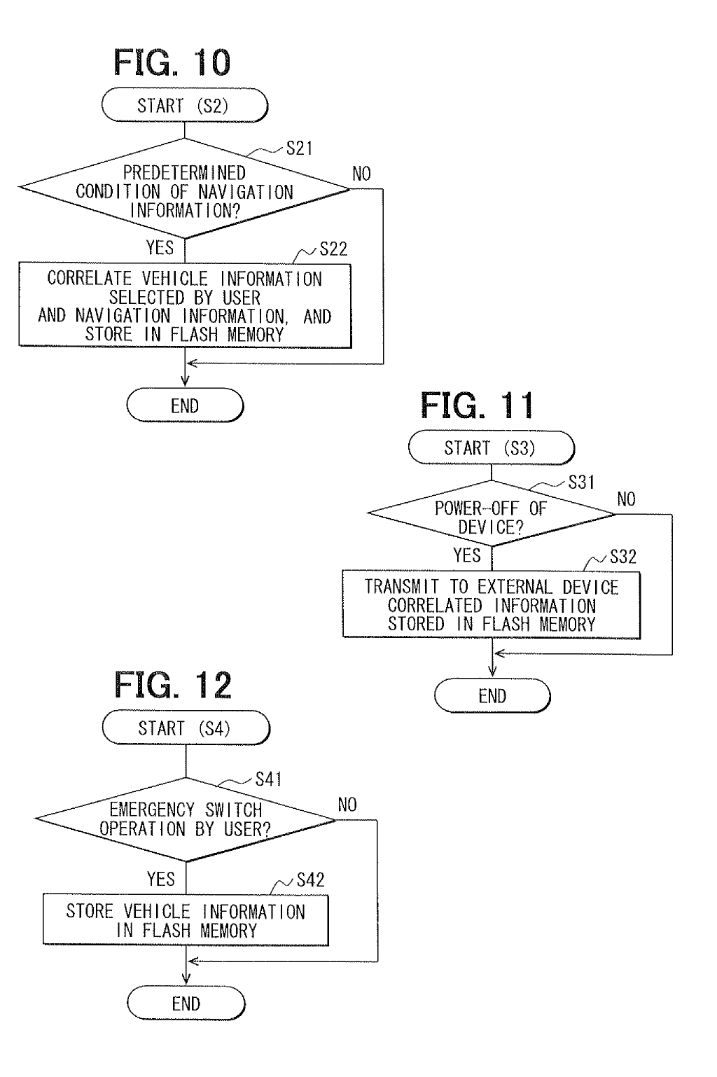

The control circuit 2 starts the vehicle information storing processing (step S2) at a time of transition to the vehicle information storing processing. In the vehicle information storing processing, as shown in FIG. 10, the control circuit 2 checks whether the navigation information received from the navigation device 28 through the display device interface circuit 8 satisfies a predetermined condition (step S21). When the control circuit 2 determines that the navigation information received from the navigation device 28 through the display device interface circuit 8 does not satisfy the predetermined condition (step S21: NO), it ends the vehicle information storing processing.

When the control circuit 2 determines that the navigation information is in a predetermined condition (step S21: YES), by determining that the vehicle location received from the navigation device 28 through the navigation device interface circuit 7 enters within a predetermined distance range from the location selected by the user in the specific item selection operation (the vehicle location and the set location are in a predetermined condition), the vehicle travel route received from the navigation device 28 through the navigation device interface circuit 7 agrees to the guide route selected by the user in the specific item selection operation (the vehicle travel route and the guide route are in a predetermined condition), and the present time received from the navigation device 28 through the navigation device interface circuit 7 agrees to the time selected by the user in the specific item selection operation (the present time and the set time are in a predetermined condition), it outputs the transfer command to the RAM 4 and the write command to the flash memory 5. The control circuit 2 thus correlate the vehicle information, which was selected by the user in the vehicle information selection operation, among the vehicle information stored in the RAM 4, and the navigation information received from the navigation device 28 through the display device interface circuit 8, and store such vehicle information and navigation information in the flash memory 5 in a correlated or associated manner (step S22). The circuit ends the vehicle information storing processing thereafter.

That is, when the user selected the camera image or the acceleration by the vehicle information selection operation and the user selected the location by the specific item selection operation, the control circuit 2 causes the flash memory 5 to store the camera image and the acceleration among the vehicle information stored in the RAM 4 and the navigation information received from the navigation device 28 in the correlated manner at the time the vehicle location becomes less than the predetermined distance relative to the location set by the user. Similarly, when the user selected the guide route by the specific item selection operation, the control circuit 2 causes the flash memory 5 to store the camera image and the acceleration among the vehicle information stored in the RAM 4 and the navigation information received from the navigation device 28 in the correlated manner at the time the vehicle travel route agrees to the guide route selected by the user. When the user selected the time by the specific item selection operation, the control circuit 2 causes the flash memory 5 to store the camera image and the acceleration among the vehicle information stored in the RAM 4 and the navigation information received from the navigation device 28 in the correlated manner at the time the present time agrees to the time selected by the user.

### (3) Vehicle Information Outputting Processing

The control circuit 2 starts the vehicle information outputting processing (step S3) at a time of transition to the vehicle information outputting processing. In the vehicle information outputting processing, as shown in FIG. 11, the control circuit 2 checks whether the power supply for the vehicle information storing apparatus 1 was shut off (step S31). When the control circuit 2 determines that the power supply for the apparatus is maintained and was not shut off (step S31: NO), it ends the vehicle information outputting processing.

When the control circuit 2 determines that the power supply for the vehicle information storing apparatus 1 was shut off based on the accessory signal received from the accessory switch 26 through the vehicle LAN interface circuit 3 (step S31: YES), it outputs the retrieval command to the output interface circuit 6 to retrieve the vehicle information and the navigation information, which have been correlated and stored in the flash memory 5 in the correlated manner, on condition that the output interface circuit 6 and the external device 27 are capable of communication with each other (step S32).

The control circuit 2 further causes the output interface circuit 6 to transmit the retrieved vehicle information and the navigation information to the external device 27, and ends the vehicle information output processing. Since the control circuit 2 performs the vehicle information outputting processing on condition that the power supply is in the power-off state, the vehicle information outputting processing is performed in the low power consumption operation.

### (4) Forced Storing Operation Receiving Processing

The control circuit 2 starts the mandatory storing operation receiving processing (step S4) at a time of transition to the mandatory storing operation receiving processing. In the mandatory storing operation receiving processing, as shown in FIG. 12, the control circuit 2 checks whether the user operated the emergency switch 33 (step S41). When the control circuit 2 determines that the user did not operate the emergency switch 33 (step S41: NO), it ends the mandatory storing operation receiving processing.

When the control circuit 2 determines that the user operated the emergency switch 33 by receiving the emergency signal transmitted from the emergency switch 33 through the emergency switch interface circuit 9 (step S41: YES), it outputs the transfer command to the RAM 4 and the write command to the flash memory 5 (step S42). These commands are issued whether the navigation information received from the navigation device 28 through the display device interface circuit 8 satisfied the predetermined condition. After the vehicle information stored in the RAM 4 is thus stored into the flash memory 5, the control circuit 2 ends the mandatory storing operation receiving processing.

As described above, when the navigation information satisfied the predetermined condition, the vehicle information selected by the user from the vehicle information stored in the RAM 4 and the navigation information received from the navigation device 28 are correlated to each other and stored in the flash memory 5. Further, when the user operated the emergency switch 33, the vehicle information stored in the RAM 4 is forcibly stored into the flash memory 5. It is also possible to correlate and store in the flash memory 5 any other vehicle information among the vehicle information stored in the RAM 4 and selected by the user and the navigation information received from the navigation device 28, when the vehicle information selected by the user satisfies the predetermined condition.

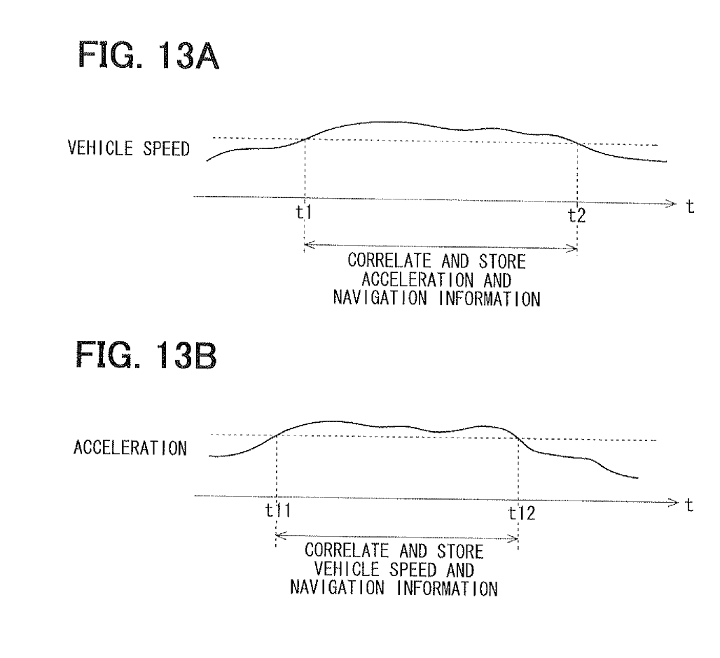

When the user selected, for example, the vehicle speed and the acceleration, the control circuit 2 stores the acceleration selected by the user among the vehicle information stored in the RAM 4 and the navigation information received from the navigation device 28 in the flash memory 5 in the correlated manner as shown in FIG. 13A. The control circuit 2 performs this operation during a period (t1 to t2), in which the vehicle speed as a reference parameter exceeds a threshold value. Further, the control circuit 2 stores the vehicle speed selected by the user among the vehicle information stored in the RAM 4 and the navigation information received from the navigation device 28 in the flash memory 5 in the correlated manner as shown in FIG. 13B. The control circuit 2 performs this operation during a period (t11 to t12), in which the acceleration as a reference parameter exceeds a threshold value.

According to the first embodiment, as described above, when the user performs the vehicle information selection operation for selecting the vehicle information such as camera image, acceleration and the like, the user performs the specific item selection operation for setting the location such as an intersection, a curve and the like, the vehicle enters within the predetermined distance range from the location set by the user, and the navigation information received from the navigation device 28 satisfies the predetermined condition, the camera image, the acceleration and the like selected by the user among the vehicle information stored in the RAM 4 are correlated with the intersection, the curve and the like, and stored in the flash memory 5. As a result, arbitrary vehicle information, which the user desires, and the navigation information are stored in the correlated manner to increase additional value. The user is thus enabled to realize how the user drove the vehicle by analyzing the camera image and the acceleration at the intersection and the curve, for example.

Further, the vehicle information stored in the RAM 4 is stored into the flash memory 5 when the user operated the emergency switch 33 whether the navigation information satisfied the predetermined condition. As a result, when the user senses an emergency situation (for example, vehicle accident) and operates the emergency switch 33, the function of storing the vehicle information, which is useful for analyzing the vehicle accident, can be ensured.

The first embodiment may be modified in the following way.

The mandatory storing operation of the vehicle information stored in the RAM 4 into the flash memory 5 may be performed when it is highly likely that a vehicle accident occurs, for example, the acceleration exceeds a predetermined value or an airbag inflates. Such conditions may be set individually or in combination.

The storage area of the flash memory 5 may be divided into a plurality of sections in correspondence to user identification information (user ID). In this case, vehicle information, which is selected by each of a plurality of users, is correlated to the user identification information, and the vehicle information selected by each user and the navigation information are correlated and stored in the flash memory 5 for each user identification information. Thus, the flash memory 5 may be shared by different users.

The vehicle information and the navigation, which are correlated and stored in the flash memory 5, need not be retrieved by the external device 27. Alternatively, a storage medium, which functions similarly to the flash memory 5 may be detachably provided so that it may be disconnected from the vehicle information storing apparatus 1 when the user gets off the vehicle. This storage medium may be connected to a data read-out device (not shown) so that the vehicle information and the navigation information stored in the correlated manner are retrieved.

### Second Embodiment

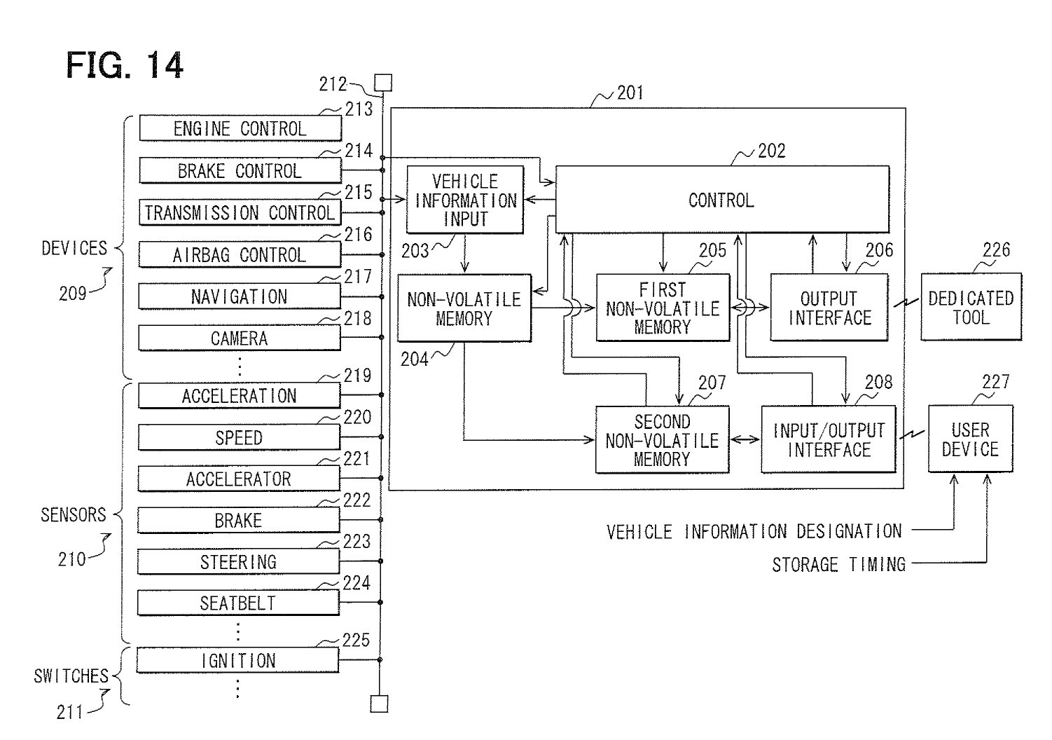

Referring to FIG. 14 showing a second embodiment, a vehicle information storing apparatus 201 is mounted in a vehicle. It is fixedly located beneath a rear seat and covered with a rigid casing in a similar manner as in the first embodiment.

The vehicle information storing apparatus 201 is configured with a control circuit (predetermined condition check section, first storing operation control section, storage timing check section, second storing operation control section, storing operation regulation section, storage condition acquisition section) 202, a vehicle information input circuit (vehicle information input section) 203, a volatile memory (volatile storage section) 204, a first non-volatile memory (first non-volatile storage section) 205, an output interface circuit (first external output section) 206, a second non-volatile memory (second non-volatile storage section) 207 and an input/output interface circuit (vehicle information designation operation receiving section, storing time designation operation receiving section, acquisition result output section and second external output section) 208. The volatile memory 204 may be a RAM and the non-volatile memories 205 and 207 may be flash memories.

The control circuit 202 includes a CPU, which is a microcomputer, a RAM, a ROM, an I/O bus and the like, and executes control programs thereby to control operations of the vehicle information input circuit 203, the volatile memory 204, the first non-volatile memory 205, the output interface circuit 206, the second non-volatile memory 207 and the input/output interface circuit 208.

The vehicle information input circuit 203 is connected via a vehicle LAN 212 to various devices (vehicle information output section) 209 mounted in the vehicle, various sensors (vehicle information output section) 210 and various switches (vehicle information output section) 211. The various devices 209 include an engine control device 213, a brake control device 214, a transmission control device 215, an airbag control device 216, a navigation device 217, a camera device 218 and the like. The engine control device 213 outputs a signal, by which a rotation speed of an engine can be specified. The brake control device 214 outputs a signal, by which a brake fluid pressure can be specified. The transmission control device 215 outputs a signal, by which a shift position can be specified. The airbag control device 216 outputs a signal, by which an airbag on/off condition can be specified. The navigation device 217 outputs a signal, by which a vehicle location can be specified. The camera device 218 outputs a signal, by which a camera image can be specified.

The various sensors 210 include an acceleration sensor 219, a vehicle travel speed sensor 220, an accelerator sensor 221, a brake sensor 222, a steering sensor 223, a seatbelt sensor 224 and the like. The acceleration sensor 219 outputs a signal, by which acceleration (accelerated velocity) can be specified. The speed sensor 220 outputs a signal, by which a travel speed (vehicle speed) can be specified. The accelerator sensor 221 outputs a signal, by which an accelerator operation amount can be specified. The brake sensor 222 outputs a signal, by which a brake operation amount can be specified. The steering sensor 223 outputs a signal, by which a steering angle of a steering wheel can be specified. The seatbelt sensor 224 outputs a signal, by which a seatbelt on/off condition can be specified.

The various switches 211 include an ignition switch 225 and the like. The ignition switch 225 outputs a signal, by which an on/off condition of the ignition switch 225 can be specified.

The information, which is specified by the signals outputted from the devices 209, the sensors 210 and the switches 211, is referred to as vehicle information generally. The devices 10, sensors 11 and switches 12 may include other devices, sensors and switches.

The vehicle information input circuit 203 receives the signals outputted from the devices 209, the sensors 210 and the switches 211 through a vehicle LAN 212 and outputs the vehicle information specified by the inputted signals to the volatile memory 204.

The volatile memory 204 receives the vehicle information outputted from the circuit 3 and sequentially stores the received vehicle information. That is, when the volatile memory 204 receives the vehicle information from the control circuit 203 in an amount, which exceeds the storage capacity of the volatile memory 204, the volatile memory 204 stores (overwrites) the latest vehicle information while erasing the oldest vehicle information, which is being stored at that moment. Thus, the vehicle information, which is received from the vehicle information input circuit 203, is sequentially stored in the volatile memory 204. When the power supply for the vehicle information storing apparatus 201 is shut off, the memory content (vehicle information) stored in the volatile memory 204 is erased.

The first non-volatile memory 205 is configured to be capable of storing a part of the vehicle information stored in the volatile memory 204. The control circuit 2 outputs a first transfer command to the first volatile memory 204 and a first write command to the first non-volatile memory 205 so that the part of vehicle information stored in the volatile memory 204 may be stored (copied) into the first non-volatile memory 205. The operation of storing the part of the vehicle information stored in the volatile memory 204 in the first non-volatile memory 205 is referred to as a first storing operation. The vehicle information stored in the first non-volatile memory 205 is predetermined vehicle information, which is useful to analyze, for example, vehicle accident. Therefore, the predetermined vehicle information stored in the first non-volatile memory 205 may be the same among vehicles. The storage content stored in the first non-volatile memory 205 is maintained without erasure, even when the power supply for the vehicle information storing apparatus 1 is shut off.

The second non-volatile memory 207 is also configured to be capable of storing a part of the vehicle information stored in the volatile memory 204 in the similar manner as the first non-volatile memory 205. The control circuit 202 outputs a second transfer command to the second volatile memory 207 and a second write command to the second non-volatile memory 207 so that the part of vehicle information stored in the volatile memory 204 may be stored (copied) into the second non-volatile memory 205. The operation of storing the part of the vehicle information stored in the volatile memory 204 in the second non-volatile memory 207 is referred to as a second storing operation. The vehicle information stored in the second non-volatile memory 207 is designated by a user (person, such as driver or owner of a vehicle having the vehicle information storing apparatus 201) and referred to as user-designated vehicle information. Therefore, the user-designated vehicle information stored in the second non-volatile memory 207 is variable among vehicles. The storage content stored in the second non-volatile memory 207 is maintained without erasure, even when the power supply for the vehicle information storing apparatus 201 is shut off.

The output interface circuit 206 has a communication function for communicating with a dedicated tool 226 provided as an external device to the vehicle information storing apparatus 201 and used by a specified person (for example, staff in charge of analyzing vehicle accident). The output interface circuit 206 operates as a circuit, which outputs the vehicle information stored in the first non-volatile memory 205 to the dedicated tool 226.

The dedicated tool 226 has a function of receiving an input operation of the specified person and displaying information thereon. When the specified person performs a read-out or retrieval operation to retrieve the vehicle information stored in the first non-volatile memory 205, the dedicated tool 226 transmits a retrieval command to the output interface circuit 206. When the output interface circuit 206 receives the retrieval command transmitted from the dedicated tool 226, it outputs the received retrieval command to the control circuit 202. The output interface circuit 206 retrieves the vehicle information stored in the first non-volatile memory 205 by applying a retrieval command from the control circuit 202 and transmits the retrieved vehicle information to the dedicated tool 226. When the dedicated tool 226 receives the vehicle information transmitted from the output interface circuit 206, it displays the received vehicle information thereon so that the special person may be provided with the vehicle information stored in the first non-volatile memory 205. The communication performed between the output interface circuit 206 and the dedicated tool 226 may be a wired communication or a short-distance wireless communication. The wired communication is USB communication and the short-distance wireless communication is Bluetooth (trademark) communication, for example.

The input/output interface circuit 208 has a communication function for communicating with a user device 227, which is operable by a user. The input/output interface circuit 208 operates as a circuit, which not only outputs the vehicle information stored in the second non-volatile memory 207 to the user device 227, which is also provided as an external device to the vehicle information storing apparatus 201, but also receives input operation performed by the user.

The user device 227 is a device such as a personal computer terminal and the like, which has high general versatility. It has a function of receiving the input operation of the user and displaying information thereon. When the user performs a read-out operation to retrieve the vehicle information stored in the second non-volatile memory 207, the user device 207 transmits a retrieval command to the input/output interface circuit 208. When the input/output interface circuit 208 receives the retrieval command transmitted from the user device 227, it outputs the received retrieval command to the control circuit 202. The input/output interface circuit 208 retrieves the vehicle information stored in the second non-volatile memory 207 by applying a read-out command from the control circuit 202 and transmits the retrieved vehicle information to the user device 227. When the user device 227 receives the vehicle information transmitted from the input/output interface circuit 208, it displays the received vehicle information thereon so that the user may be provided with the vehicle information stored in the second non-volatile memory 207.

When the user performs the vehicle information designation operation to designate the vehicle information, which the user requests, the user device 227 transmits a vehicle information designation signal, by which the vehicle information designated by the user can be specified, to the input/output interface circuit 208. When the input/output interface circuit 208 receives the vehicle information designation signal transmitted from the user device 227, it outputs the received vehicle information designation signal to the control circuit 202. When the control circuit 202 receives the vehicle information designation signal outputted from the input/output interface circuit 208, it sets (store and maintain storage content) the user-designated vehicle information specified by the received vehicle information designation signal.

When the user performs a storing time designation operation to designate a desired storing time, the user device 227 transmits a storing time designation signal, by which the storing time designated by the user can be specified, to the input/output interface circuit 208. When the input/output interface circuit 208 receives the storing time designation signal transmitted from the user device 227, the input/output interface circuit 208 outputs the received storing time designation signal to the control circuit 202. When the control circuit 202 receives the storing time designation signal outputted from the input/output interface circuit 208, it sets (store and maintain storage content) the storing time designated by the user and specified by the received storing time designation signal. The communication performed between the input/output interface circuit 208 and the user device 227 may also be a wired communication or a short-distance wireless communication. For example, the wired communication is USB communication and the short-distance wireless communication is Bluetooth (trademark) communication, for example.

When the control circuit 202 receives the signals outputted from the devices 209, the sensors 210 and the switches 211 through the vehicle-mounted LAN 212, it analyzes the received signals. By monitoring the storage condition of the second non-volatile memory 207, the control circuit 202 acquires the storage condition of the second non-volatile memory 207 and outputs the acquired storage condition to the input/output interface circuit 208. The storage condition of the second non-volatile memory 207 indicates amount of storage capacity in the second non-volatile memory 207, which is not used for storage and is still available for storing vehicle information, and amount of storage capacity in the second non-volatile memory 207, which is used for storing the vehicle information and not available). When the input/output interface circuit 208 receives the storage condition acquisition result outputted from the control circuit 202, it transmits the received storage condition acquisition result to the user device 227. When the user device 227 receives the storage condition acquisition result transmitted from the input/output interface circuit 208, it displays the received storage condition acquisition result thereon to notify the user of the storage condition of the second non-volatile memory 207.

The vehicle information storing apparatus 201 configured as described above is connected to respond to on/off condition of the ignition switch 225 by receiving the ignition signal of the ignition switch 225 under a condition that it is mounted in the vehicle. The power supply for the vehicle information storing apparatus 201 is turned on and off (the vehicle information storing apparatus 201 is activated and stopped) when the ignition switch 225 is turned on and off, respectively.

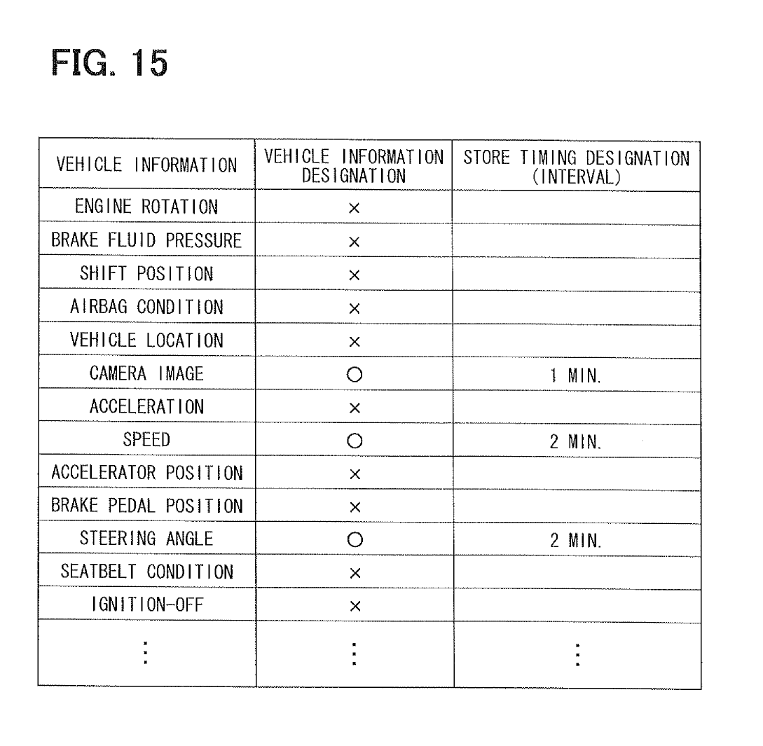

As describe above, while the input/output interface circuit 208 and the user device 227 are capable of communication with each other, the user is enabled to set the designated vehicle information and the designated storing time in the control circuit 202 by performing the vehicle information designation operation and the storing time designation operation on the user device 227. The storing time indicates an interval or a condition, by which the user-designated vehicle information among the vehicle information stored in the volatile memory 204, is stored in the second non-volatile memory 207. FIG. 15 shows one example of designation, by which the user designates the vehicle information and the storing time (interval). In this example, the vehicle information and the storing time are designated such that the camera image outputted from the camera device 218 is stored at an interval of one minute, the vehicle speed outputted from the speed sensor 220 is stored at an interval of two minutes and the steering angle outputted from the steering sensor 223 is stored in an interval of two minutes.

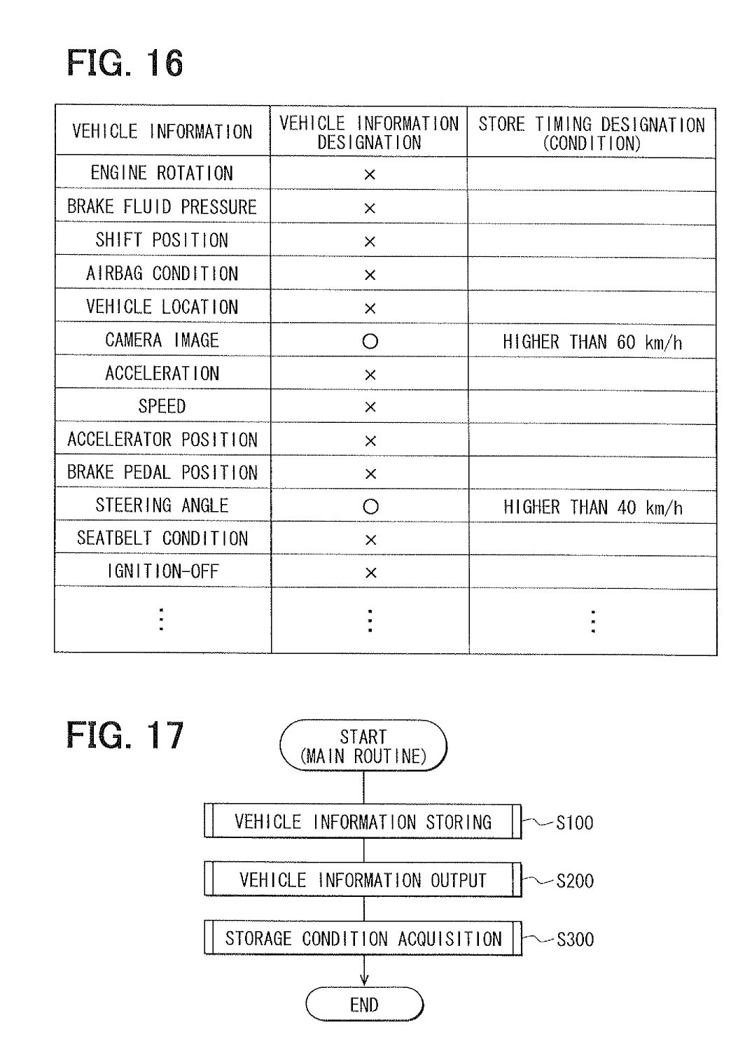

FIG. 16 shows another example of designation, by which the user designates the vehicle information and the storing time (condition). In this example, the vehicle information and the storing time are designated such that the camera image outputted from the camera device 218 is stored on condition that the vehicle speed is over 60 km/hr, the steering angle outputted from the steering sensor 223 is stored on condition that the vehicle speed is higher than 40 km/hr. It is also possible to designate the interval and the condition as the storing time for one vehicle inform at the same time. For example, the camera image may be stored at every interval of one minute or at travel speed of over 60 km/hr. It is further possible to designate a plurality of conditions. For example, the camera image may be stored at travel speed of more than 60 km/hr and steering angle of more than 20 degrees. Alternatively, the camera image may be stored at travel speed of more than 60 km/hr or steering angle of more than 20 degrees.

The operation of the vehicle information storing apparatus 201 will be described with reference to FIGS. 17 to 20.

In the vehicle information storing apparatus 201, the control circuit 202 performs a main routine (processing) including sub-routines (sub-processing) shown in FIG. 17, when the power supply to the vehicle information storing apparatus 201 is in the turned-on state (ignition switch 225 is maintained in the on-state). The sub-routines are vehicle information storing processing (step S100), vehicle information outputting processing (step S200) and storage condition acquisition processing (step S300). The control circuit 202 repeats a series of the vehicle information storing processing, the vehicle information outputting processing and the storage condition acquisition processing at a predetermined interval as described below. The control circuit 202 ends the main routine when the power supply to the vehicle information storing apparatus 201 is shut off. The foregoing processing will be described in sequence.

### (1) Vehicle Information Storing Processing

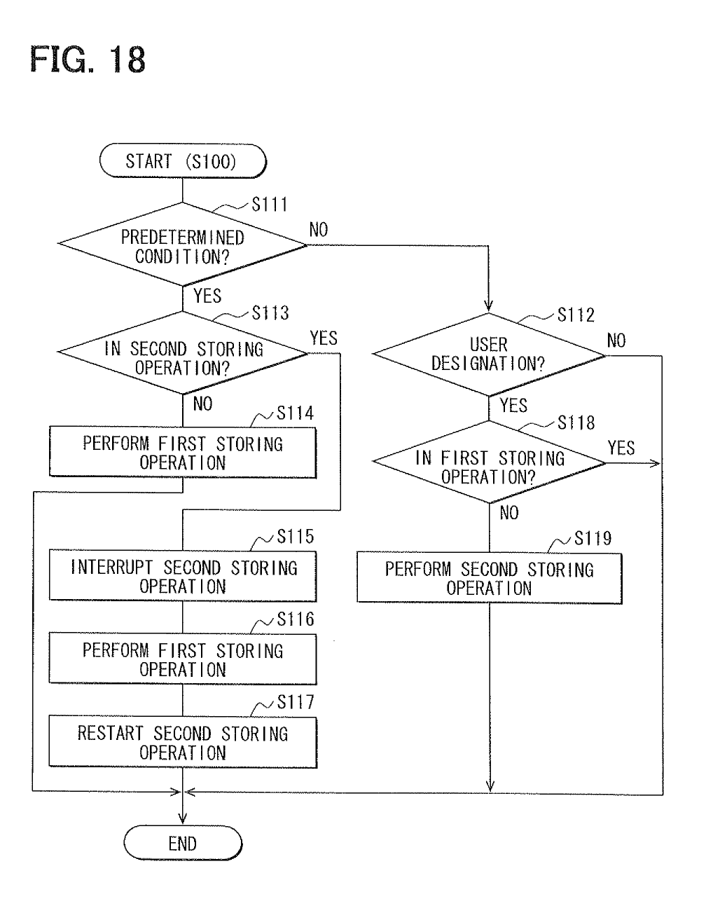

The control circuit 202 starts the vehicle information storing processing (step S100) at a time of transition to the vehicle information storing processing. In the vehicle information storing processing, as shown in FIG. 18, the control circuit 202 checks whether a predetermined condition is satisfied (step S111) and whether user designated the storing time (step S112).

When the control circuit 202 determines that the predetermined condition is satisfied by determining, for example, that the acceleration exceeded the threshold value based on the signal outputted from the acceleration sensor 19, that is, a start request for the first storing operation was generated (step Sill: YES), it checks whether the second storing operation is being performed at that time, that is, the user-designated vehicle information among the vehicle information stored in the volatile memory 204 is being stored in the second non-volatile memory 207 at the storing time designated by the user (step S113).

When the control circuit 202 determines that the second storing operation is not being performed (step S113: NO), it outputs the first transfer command to the volatile memory 204 and outputs the first write command to the first non-volatile memory 205. The control circuit 202 thus performs the first storing operation to store predetermined vehicle information among the vehicle information stored in the volatile memory 204 into the first non-volatile memory 205 (step S114). The control circuit 2 ends the vehicle information storing processing after completing the first storing operation.

When the control circuit 202 determines that the second storing operation is being performed (step S113: YES), it interrupts the second storing operation (step S115), which is being performed, and performs the first storing operation (step S116). Thus, the control circuit 202 performs the first storing operation with priority over the second storing operation. The control circuit 202 restarts the interrupted second storing operation (step S117) after completing the first storing operation. The control circuit 202 ends the vehicle information storing processing after completing the second storing operation.

When the control circuit 202 determines that it is the storing time designated by the user, that is, the start request for the second storing operation was generated (step S112: YES), it checks whether the first storing operation is being performed at that time, that is, the predetermined vehicle information among the vehicle information stored in the volatile memory 204 is being performed in the first non-volatile memory 205 (step S118).

When the control circuit 202 determines that the first storing operation is not being performed (step S118: NO), it outputs the second transfer command to the volatile memory 204 and outputs the second write command to the second non-volatile memory 207. The control circuit 202 thus performs the second storing operation to store the user-designated vehicle information among the vehicle information stored in the volatile memory 204 into the second non-volatile memory 207 (step S119). The control circuit 202 ends the vehicle information storing processing after completing the second storing operation. When the control circuit 202 determines that the first storing operation is being performed (step S118: YES), it ends the vehicle information storing processing without performing the second storing operation. That is, the control circuit 202 waits until the first storing operation is completed. When the control circuit 202 determines that the first storing operation for the predetermined vehicle information is not being performed because the first storing operation has been completed (step S118: NO), it starts the second storing operation for the user-designated vehicle information (step S119).

### (2) Vehicle Information Outputting Processing

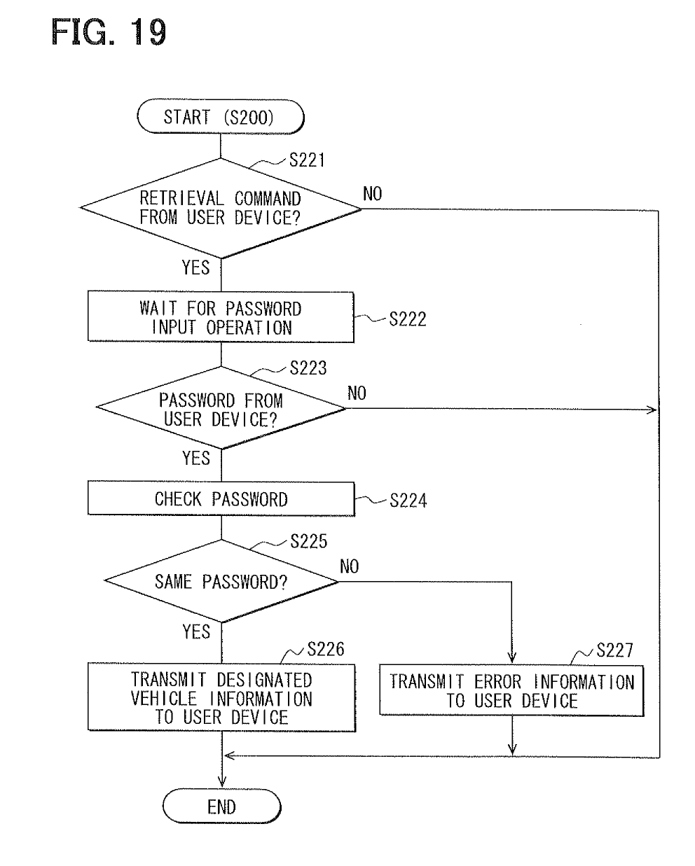

The control circuit 2 starts the vehicle information outputting processing (step S200) at a time of transition to the vehicle information outputting processing. In the vehicle information outputting processing, as shown in FIG. 19, the control circuit 202 checks whether the input/output interface circuit 208 received the retrieval command transmitted from the user device 227 (step S221). When the control circuit 202 determines that the input/output interface circuit 208 received the retrieval command transmitted from the user device 227 in response to the retrieval operation performed by the user to retrieve the vehicle information stored in the second non-volatile memory 207 (step S221: YES), it causes the input/output interface circuit 208 to transmit a password request command to the user device 227 and waits for the input operation of the password by the user (step S222).

When the control circuit 202 determines that the input/output interface circuit 208 received the password inputted by the user and transmitted from the user device 227 (step S223: YES), it checks whether the received password is the same as a predetermined password (step S224). When the control circuit 202 determines that the inputted password is the same as the predetermined password (step S225: YES), it outputs the second retrieval command to the input/output interface circuit 208 and causes the input/output interface circuit 208 to retrieve the vehicle information, which was designated by the user among the vehicle information stored in the second non-volatile memory 207 at the storing time designated by the user. The control circuit 202 thus causes the input/output interface circuit 208 to transmit the retrieved vehicle information to the user device 207 (step S226). When the user device 227 receives the vehicle information transmitted from the vehicle information storing apparatus 201, it displays the received vehicle information thereby to provide the user with the user-designated vehicle information stored at the user-designated storing time.

When the control circuit 202 determines that the inputted password is not the same as the predetermined password (step S225: NO), it does not output the second retrieval command to the input/output interface circuit 208 but outputs an error notification command to the input/output interface circuit 208. Thus the control circuit 202 causes the input/output interface circuit 208 to transmit error information to the user device 207 (step S227). When the user device 227 receives the error information transmitted from the vehicle information storing apparatus 201, it displays the received error message (for example, message indicating inputted password is not correct) so that the user will understand that the inputted password is in error and not accepted.

### (3) Storage Condition Acquisition Processing

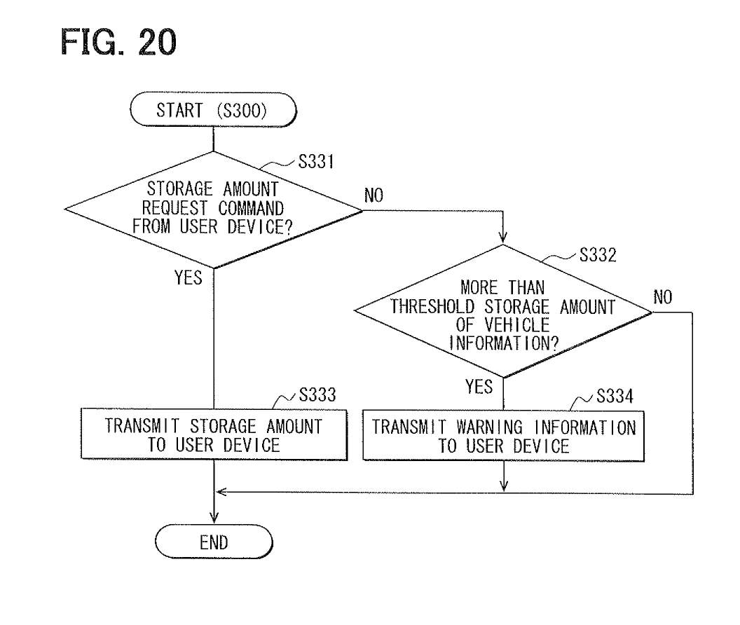

The control circuit 2 starts the storage condition acquisition processing (step S300) at a time of transition to the store condition acquisition processing. In the store condition acquisition processing, as shown in FIG. 20, the control circuit 202 checks whether the input/output interface circuit 208 received the storage amount request command transmitted from the user device 227 and checks whether the storage amount of the second non-volatile memory 207 storing the designated vehicle information exceeded the threshold value (for example, 80% of the total amount) (steps S331, S332).

When the control circuit 202 determines that the input/output interface circuit 208 received the storage amount request command from the user device 227 in response to the storage amount request operation by the user requesting the storage amount in the second non-volatile memory 207 (step S331: YES), the control circuit 202 measures at least one of the storage amount in the memory 207, in which the user-designated vehicle information is not yet stored, and the storage amount in the second non-volatile memory 207, in which the user-designated vehicle information is stored, and causes the input/output interface circuit 208 to transmit the measured storage amount to the user device 227 (step S333). When the user device 227 receives the storage amount transmitted from the vehicle information storing apparatus 201, it displays the received storage amount thereby to provide the user with information about at least one of the storage amount in the memory 207, in which the user-designated vehicle information is not yet stored, and the storage amount in the second non-volatile memory 207, in which the user-designated vehicle information is stored.

When the control circuit 202 determines that the storage amount of the user-designated vehicle information stored in the second non-volatile memory 207 exceeds the threshold value (step S332: YES), the control circuit 202 causes the input/output interface circuit 208 to transmit the warning information, which indicates that the storage amount of the user-designated vehicle information in the second non-volatile memory 207 exceeded the threshold value, to the user device 227 (step S333). When the user device 227 receives the warning information transmitted from the device 201, it displays the received warning information (for example, available storage amount is 20%) thereby to provide the user with notification that the user-designated vehicle information stored in the second non-volatile memory 207 occupies more than the threshold value.

As described above, in the vehicle information storing apparatus 201 according to the second embodiment, when the predetermined condition, in which the predetermined vehicle information among the vehicle information stored in the non-volatile memory 204 is stored into the first non-volatile memory 205, is satisfied, the predetermined vehicle information is stored in the first non-volatile memory 205. Further, the user designates the vehicle information and the storing time. When it is the designated time, the information designated by the user as the user-designated vehicle information among the vehicle information stored in the volatile memory 204 is stored into the second non-volatile memory 207. Thus, when the predetermined condition is satisfied, not only the predetermined vehicle information is stored periodically at a regular interval but also the user-designated information is stored at the user-designated storing time, thereby increasing added value.

The operation of storing the predetermined vehicle information into the first non-volatile memory 205 is performed with priority over the operation of storing the user-designated vehicle information into the second non-volatile memory 207. As a result, the predetermined vehicle information can be stored into the first non-volatile memory 205 surely regularly.

The amount of storage capacity of the second non-volatile memory 207, which is already used or not yet used, is displayed by the user device 227. As a result, the user is enabled to receive a certain index, which vehicle information or which storing time should be designated, in case of designating the vehicle information or the storing time.

Further, the dedicated tool 226 is used as a device for retrieving the predetermined vehicle information and the user device 227 different from the dedicated tool 226 is used as a device for retrieving the vehicle information, which the user desires. The user is allowed to retrieve the desired vehicle information by himself or herself, while protecting the predetermined vehicle information from being retrieved by any other persons.

The second embodiment may be modified as follows.

The predetermined condition for storing the predetermined vehicle information among the vehicle information stored in the volatile memory 204 into the first non-volatile memory 205 is not limited to that the acceleration exceeds the threshold value. The predetermined condition may be other condition, which specifies high possibility of vehicle accident, such as activation of an airbag. The predetermined condition may be single or combined.

The storage area in the second non-volatile memory 207 may be divided into a plurality of sections and correlated to user identification information (user ID). The user-designated vehicle information designated by each user may be correlated to the user identification information and stored in the correlated manner in the second non-volatile memory 207. Thus, the second non-volatile memory 207 may be shared by a plurality users.

The predetermined vehicle information stored in the first non-volatile memory 205 may be retrieved by a device other than the dedicated tool 226. It is possible to configure the first non-volatile memory 205 to be detachable from the vehicle information storing apparatus 201, so that the first non-volatile memory 205 may be detached from the apparatus 1 after occurrence of vehicle accident (after the predetermined vehicle information is stored in the first non-volatile memory 205). The first non-volatile memory 205 detached from the vehicle information storing apparatus 201 may be connected to a retrieval device, for example, thereby to read out the predetermined information stored in the first non-volatile memory 205.

The user-designated vehicle information stored in the second non-volatile memory 207 may be retrieved by a device other than the user device 227. It is possible to configure the second non-volatile memory 207 to be detachable from the vehicle information storing apparatus 201, so that the second non-volatile memory 207 may be detached from the vehicle information storing apparatus 1 after the user finishes driving of a vehicle (after the user-designated vehicle information is stored in the second non-volatile memory 207 at the user-designated storing time). The second non-volatile memory 207 detached from the vehicle information storing apparatus 201 may be connected to a retrieval device, for example, thereby to read out the user-designated information stored in the second non-volatile memory 207.

What is claimed is:

1. A vehicle information storing apparatus for a vehicle having a navigation device, the vehicle information storing apparatus comprising:
a vehicle information input section for receiving vehicle information during travel of a vehicle;
a volatile storage section for storing sequentially the vehicle information received by the vehicle information input section;
a non-volatile storage section for storing the vehicle information stored in the volatile storage section;
a vehicle information selection operation receiving section for receiving a vehicle information selection operation performed by a user to select the vehicle information;
a navigation information inputting section for receiving navigation information from the navigation device; and
a control section for checking whether the navigation information received by the navigation information input section satisfies a predetermined condition,
wherein the control section is configured to correlate and store in the non-volatile storage section the vehicle information and the navigation information, when the navigation information is determined to satisfy the predetermined condition, the vehicle information being selected by the vehicle information selection operation of the user from the vehicle information stored in the volatile storage section.

2. The vehicle information storing apparatus according to claim 1, wherein:
the control section is configured to correlate and store in the non-volatile storage section the vehicle information and a set location set by a user by the navigation device, when a vehicle location and the set location satisfy a predetermined condition.

3. The vehicle information storing apparatus according to claim 1, wherein:
the control section is configured to correlate and store in the non-volatile storage section the vehicle information and a set guide route set by a user by the navigation device, when a vehicle travel route and the set guide route satisfy a predetermined condition.

4. The vehicle information storing apparatus according to claim 1, wherein:
the control section is configured to correlate and store in the non-volatile storage section the vehicle information and a set time set by a user by the navigation device, when a present time and the set time satisfy a predetermined condition.

5. The vehicle information storing apparatus according to claim 1, wherein:
the vehicle information input section is configured to receive image information indicative of a specific image of a vehicle surrounding; and
the control section is configured to correlate and store in the non-volatile storage section the image information and the navigation information, when the navigation information satisfy a predetermined condition, the image information being selected by the vehicle information selection operation from the vehicle information stored in the volatile storage section.

6. The vehicle information storing apparatus according to claim 1, wherein
the vehicle information input section is configured to receive acceleration information indicative of specific acceleration of the vehicle; and
the control section is configured to correlate and store in the non-volatile storage section the acceleration information and the navigation information, when the navigation information satisfy a predetermined condition, the acceleration information being selected by the vehicle information selection operation from the vehicle information stored in the volatile storage section.

7. The vehicle information storing apparatus according to claim 1, further comprising:
a navigation function selection operation receiving section for receiving a navigation function selection operation performed by the user to select a navigation function,
wherein the control section is configured to select the vehicle information based on the navigation function selected by the navigation function selection operation, and
wherein the control section is configured to correlate and store in the non-volatile storage section the vehicle information and the navigation information, when the navigation information satisfies a predetermined condition, the vehicle information being selected from the vehicle information stored in the volatile storage section based on the navigation function.

8. The vehicle information storing apparatus according to claim 1, further comprising:
a drive stop check section for checking whether a drive power source is stopped; and
an external output section for outputting externally the vehicle information and the navigation information correlated and stored in the non-volatile memory on condition that the drive power source is stopped.

9. The vehicle information storing apparatus according to claim 1, wherein:
the control section is configured to correlate and store in the non-volatile storage section other vehicle information and the navigation information, when a part of the vehicle information selected by the vehicle information selection operation satisfies a predetermined condition, another part of the vehicle information being selected by the vehicle information selection operation from the vehicle information stored in the volatile storage section.

10. The vehicle information storing apparatus according to claim 1, further comprising:
a mandatory storing operation receiving section for receiving a mandatory storing operation performed by the user,
wherein the control section is configured to store in the non-volatile storage section the vehicle information stored in the volatile storage section, when the mandatory storing operation by the user is received by the mandatory storing operation receiving section.

11. A vehicle information control apparatus comprising:
a vehicle information input section for receiving vehicle information during travel of a vehicle;
a volatile storage section for storing sequentially the vehicle information received by the vehicle information input means;
a first non-volatile storage section provided to store predetermined vehicle information among the vehicle information stored in the volatile storage section;
a predetermined condition check section for checking whether a predetermined condition, in which the predetermined vehicle information is to be stored in the first non-volatile storage section, is satisfied;
a first storing operation control section for performing a first storing operation to store the predetermined vehicle information in the first non-volatile storage section when the predetermined condition check section determines that the predetermined condition is satisfied;
a vehicle information designation operation receiving section for receiving a vehicle information designation operation performed by a user to designate user-designated vehicle information among the vehicle information stored in the volatile storage section;
a storing time designation operation receiving section for receiving a storing time designation operation performed by the user to designate a storing time;
a storing time check section for checking whether the storing time is designated as a user-designated storing time by the storing time designation operation receiving section;
a second non-volatile storage section provided separately from the first non-volatile storage section to store the user-designated vehicle information; and
a second storing operation control section for storing the user-designated vehicle information in the second non-volatile storage section at the user-designated storing time.

12. The vehicle information control apparatus according to claim 11, wherein:
the storing time designation operation receiving section receives, as the storing time designation operation, an operation of designating an interval, at which the user-designated vehicle information is stored; and
the second storing operation control section performs the second storing operation when the user-designated storing time check section determines that the interval designated by the user is satisfied.

13. The vehicle information control apparatus according to claim 11, wherein:
the storing time designation operation receiving section receives, as the storing time designation operation, an operation of designating a condition, under which the user-designated vehicle information is stored; and
the second storing operation control section performs the second storing operation when the storing time check section determines that the condition designated by the user is satisfied.

14. The vehicle information control apparatus according to claim 11, further comprising:
a storing operation regulation section for regulating operation times of the first storing operation and the second storing operation,
wherein the storing operation regulation section performs the first storing operation with priority over the second storing operation.

15. The vehicle information control apparatus according to claim 14, wherein:
the storing operation regulation section interrupts the second storing operation and starts the first storing operation, when the second storing operation is being performed at a time of generation of a request for starting the first storing operation.

16. The vehicle information control apparatus according to claim 15, wherein:
the storing operation regulation section restarts the second storing operation interrupted by the storing operation regulation section after completing the first storing operation.

17. The vehicle information control apparatus according to claim 14, wherein:
the storing operation regulation section starts the second storing operation after completion of the first storing operation without interrupting the first storing operation, when the first storing operation is being performed at a time of generation of a request for starting the second storing operation.

18. The vehicle information control apparatus according to claim 11, further comprising:
a storage condition acquisition section for acquiring a storage condition of the vehicle information in the second non-volatile storage section; and
an acquisition result output section for outputting an acquisition result of the storage condition acquisition section to an external device provided outside.

19. The vehicle information control apparatus according to claim 11, wherein.
the storage condition acquisition section acquires at least one of used and non-used storage amounts of the second non-volatile storage section, by which the vehicle information is already stored and not yet stored, respectively; and
the acquisition result output section outputs one of the used and the non-used storage amounts to the external device.

20. The vehicle information control apparatus according to claim 11, further comprising:
a first output section for outputting the vehicle information stored in the first non-volatile storage section to an outside when connected to a dedicated tool; and
a second output section for outputting the vehicle information stored in the second non-volatile storage section to an outside when connected to a user device provided separately from the dedicated tool.
